(19) United States
(12) Patent Application Publication
(10) Pub. No.: US 2010/0138732 A1
(43) Pub. Date: Jun. 3, 2010

(54) METHOD FOR IMPLEMENTING SMALL DEVICE AND TOUCH INTERFACE FORM FIELDS TO IMPROVE USABILITY AND DESIGN

(75) Inventors: Mary Bowden, Bristol (GB); David Rowell, Bristol (GB)

Correspondence Address: Perman & Green, LLP, 99 Hawley Lane, Stratford, CT, 06614, US

(73) Assignee: NOKIA CORPORATION, Espoo (FI)

(21) Appl. No.: 12/325,036

(22) Filed: Nov. 28, 2008

(51) Int. Cl. G06F 17/00

(52) U.S. Cl. 715/221

(57) ABSTRACT

A method that includes providing a form label of a first size inside a form field where data is to be entered, detecting data entry into the form field, and reducing the form label to a second smaller size when data is entered into the form field, so that both the form label and entered data are simultaneously viewable in the form field.

### BACKGROUND

1. Field

The aspects of the disclosed embodiments generally relate to user interfaces and more particularly to a user interface for entering data into form fields.

2. Brief Description of Related Developments

Form fields are used to enter data, such as registration or payment information in a form. These forms can include for example, web-based forms. Most form fields have an associated label in the interface that describes to the user what data needs to be entered into each specific form field. These labels are particularly important in a form that contains several form fields, and provide feedback to the user so the user can complete and submit the form with as few errors as possible. Generally, form labels are provided above or beside the form field where the data is to be entered. In some cases, the form labels are pop-up boxes or windows that appear when the cursor is placed at or near the form field.

In a small-screen device such as, for example, a mobile communication device, display area is limited, making it more difficult to clearly display the form fields and labels on the screen, especially when the labels are located above or beside the form field. Forms that are poorly laid out and crowded can cause confusion for the user and lower completion rates. This can be a problem when, for example, the user is filling out a web based form to make a purchase, and particularly when using a mobile communication device or terminal.

In a touch screen device, this problem is compounded, as the form field must be large enough to allow a user to easily touch the field using their finger or a stylus. Thus, the form fields must be larger, causing the display to become even more crowded. Often, on small screen devices, a label is combined with the form field. The label is displayed inside the form field until the user begins to enter data, at which time the label is automatically removed. On longer forms, this can cause the user some confusion, as they may soon forget what data was required for each specific field. Another common approach is to leave the label inside the form field during data entry. With this method, however, the entered text and label often overlap, which makes it difficult to read the entered text. Also, using this format, upon submission the label text will be submitted along with the entered data.

It would be advantageous to be able to simultaneously and clearly view both the form label and entered data inside a form field, particularly when using a device having a small or limited size display area.

### SUMMARY

The aspects of the disclosed embodiments are directed to at least a method, apparatus, user interface and computer program product. In one embodiment the method includes providing a form label of a first size inside a form field where data is to be entered, detecting data entry into the form field, and reducing the form label to a second smaller size when data is entered into the form field, so that both the form label and entered data are simultaneously viewable in the form field.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIG. 2 illustrates an example of an exemplary process incorporating aspects of the disclosed embodiments;

FIG. 3A-3E illustrate exemplary user interfaces incorporating aspects of the disclosed embodiments;

FIGS. 4A and 4B are illustrations of exemplary devices that can be used to practice aspects of the disclosed embodiments;

FIG. 5 illustrates a block diagram of an exemplary system incorporating features that may be used to practice aspects of the disclosed embodiments; and

FIG. 6 is a block diagram illustrating the general architecture of an exemplary system in which the devices of FIGS. 4A and 4B may be used.

### DETAILED DESCRIPTION OF THE EMBODIMENT(S)

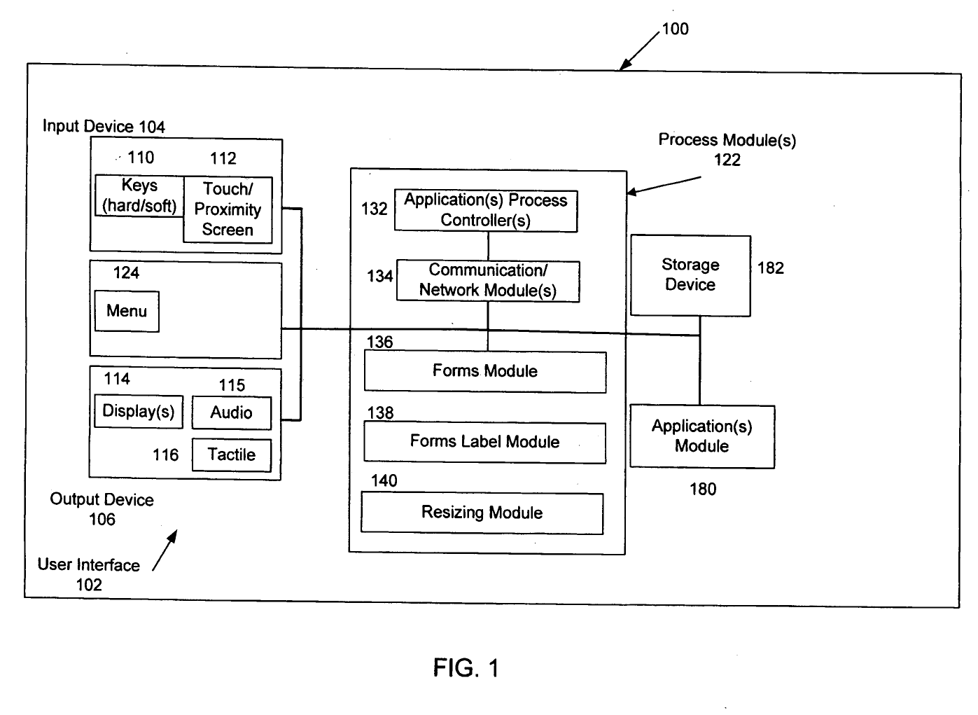

FIG. 1 illustrates one embodiment of a system 100 in which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used.

The aspects of the disclosed embodiments generally provide for reducing the amount of space required to adequately and clearly display form labels for form fields on a small sized screen on a device such as, for example, a mobile communications device. In one embodiment, a label that describes the information and/or data required in a form field will be displayed inside the form field. The label can comprise textual or graphic information that conveys to the user the type of information or data that is required to be inputted. As the user enters data the label will be reduced in size sufficient to accommodate both the label and the inputted data. Using the aspects of the disclosed embodiments, a user can easily enter the required data without forgetting what information they are supposed to enter. Placing the label inside the form field also allows for adequate space on a screen to display more form labels, for example, on a long form with multiple form fields. This also allows the form fields to be made larger when, for example, the device includes a touch screen.

As a non-limiting example, the disclosed embodiments will be described with respect to the presentation of form labels of a web based form, but it should be understood that any suitable form may be presented in the manner described herein, including but not limited to word processing documents, workbooks, worksheets, PDF forms, spreadsheets and any other form or document that requires data and information to be entered.

In one embodiment, the system 100 shown in FIG. 1 can comprise a communications device, such as a mobile communications device. The mobile communications device 100 can include an input device 104, output device 106, process modules 122, applications module 180 and storage device 182. The components described herein are merely exemplary and are not intended to encompass all components that can be included in the system 100. The system 100 can also include one or more processors or computer program products to execute the processes, methods, sequences, algorithms and instructions described herein.

In one embodiment the device 100 includes a forms module 136. The forms module 136 is generally configured to produce and present form related displays to a user via the output device 106. The forms module 136 is generally configured to interface with, for example, the applications module 180 and application process controllers 132 to obtain the data and information to present the form data on the display 114 of the output device 106.

In one embodiment, the process module 122 can also include a forms label module 138. The forms label module 138 is generally configured to provide form labels for form fields in a form type of document or web page. Although the forms label module 138 is described herein as a module distinct from the forms module 136, in one embodiment the forms label module 138 can be part of and form the forms module 136. In one embodiment, the forms label module 138 can be configured to detect a size of a display area associated with the device 100. If the detected size corresponds to a small or limited size display area, the forms label module 138 is configured to present the form labels within the corresponding form field, in accordance with the aspects of the disclosed embodiments described herein. If the detected size corresponds to a standard or large size display area, the forms label module 138 can be configured to present the form labels in a standard fashion or allow the user to choose between the different presentation and use options.

In accordance with the aspects of the disclosed embodiment, the system 100 can include a forms label resizing module 140. As will be described herein, in one embodiment, as data is inputted into a form field, the associated form label will be resized to allow the form field label and input data to co-exist within the same form field input area, in a fashion that allows the user to easily view and distinguish both the form label and the inputted data. The resizing module 140 is configured to enable the resizing of text on a form that is active or open. In one embodiment, the resizing module 140 is activated by using an input key or device of the device 100 or detection of an activation of the forms label module 138 functionality. The activation of the resizing module 140 can cause text displayed in a form field on the output device 106 to become smaller or larger, highlighted or otherwise distinguished relative to inputted data and other information on the display as described herein.

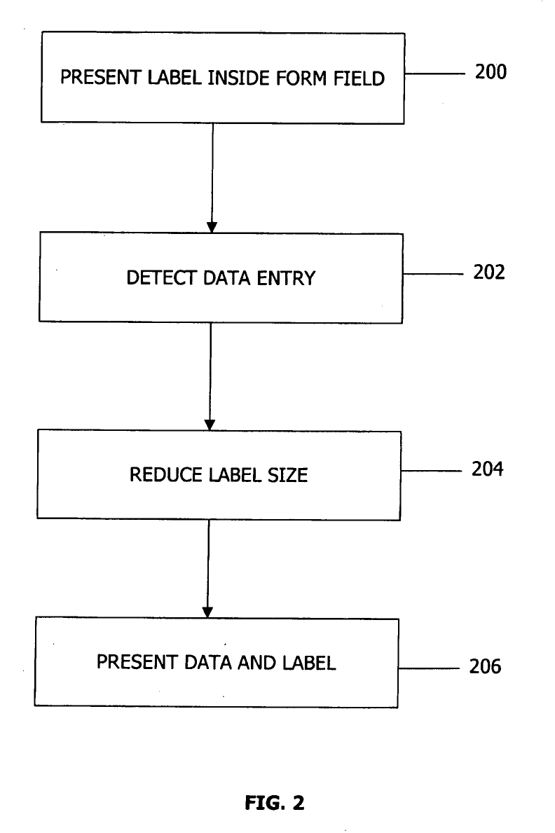

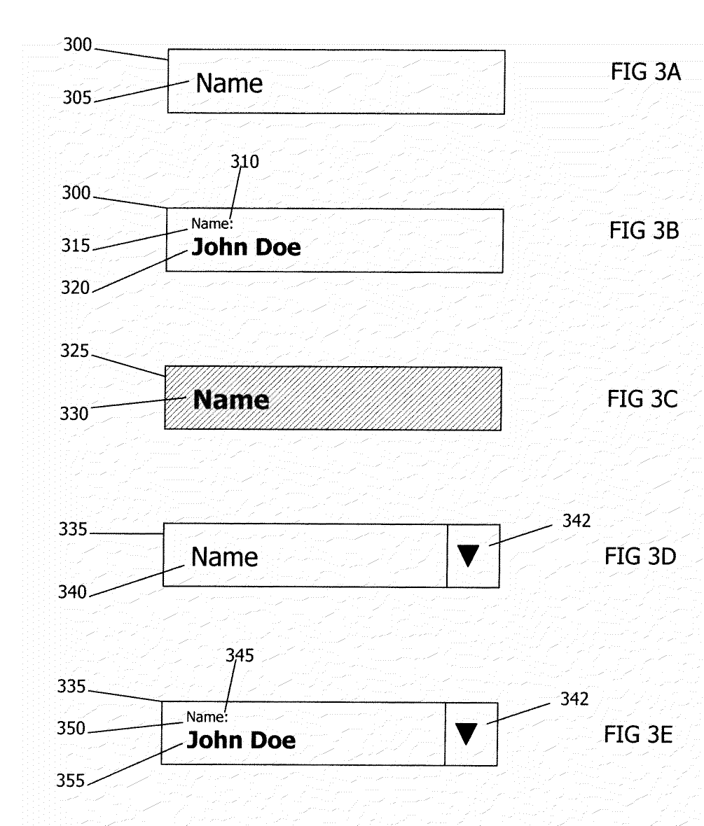

Referring to FIGS. 2 and 3A-3B, an exemplary process flow incorporating aspects of the disclosed embodiments is illustrated. As shown in FIG. 3A, a label 305 is displayed 200 inside a form field 300. A user enters data 202 into the form field. In this example, the label 305 comprises textual information. In alternate embodiments, the label 305 can comprise any suitable information or data in any suitable format. The size of the label 305 is adjusted to fit within the field 300. In alternate embodiments, the label 305 can be sized in any suitable fashion. In one embodiment, the label 305 can also be highlighted to distinguish the label 305 from any data that is inputted or presented within a field 300. For example, the label 305 can be formatted as a grayscale image. Alternatively, the label 305 can be colored or presented in a stylized fashion. In this example, the label 305 is also presented in a somewhat centered fashion within the field 300. In alternate embodiments, the label 305 can be presented in any suitable area of the field 300.

As shown in FIG. 3B, the data “John Doe” 320 is entered into the field 300 in any suitable manner. In accordance with the aspects of the disclosed embodiments, when the data entry is detected, the size of the form label 305 of FIG. 3A, is reduced in size 204 to that shown by label 315 in FIG. 3B, so that both the data entry 320 and the form label 315 are presented simultaneously 206 within the field 300. As exemplified in FIG. 3B, the label 315 is positioned within the field 300 so that the label 315 is distinguishable from the data entry 320. In this example, the label 315 is positioned above and to the left within the field 300. In alternate embodiments, the label 315 can be positioned at any suitable location within the field 300 that allows the label 315 to be viewable within the field 300 together with the data entry 320, for example, below the entered data. In one embodiment, the label 315 is positioned and resized so that the label 315 and the entered data 320 are arranged in a non-interfering manner inside the form 300.

In one embodiment, as shown in FIG. 3B, an identifier 310 can be added to the label 305 when the label is resized to the label 315. In one embodiment, the identifier 310 can comprise a colon or other suitable character that distinguishes the label 315 as the form label information. In this example, the colon can be used to inform the user that the area and text 320 below the label 315 is the data input area or data input. In one embodiment, the resized label 315 may also be highlighted, colored, or presented in a stylized fashion so as distinguish it from the entered data 320 when the two are simultaneously presented 206. In alternate embodiments, the input data 320 may likewise be colored, highlighted, or otherwise formatted in a stylized manner so as to further distinguish it from the label 315.

In one embodiment, if a user decides to delete the entered data 320 from the form field 300, the data is incorrectly entered, or incorrect data is entered, the label can be resized to its original form, or made larger to appear similar to the original label 305 inside the form field 300. This is to allow the user to easily distinguish that the field 300 is now empty or cleared and data can be or is needed to be entered. In another embodiment, referring to FIG. 3C, if an error is detected in the input data, an error message 330 will be presented in place of the original form label. In one embodiment, as shown in FIG. 3C, the form field 325 which contains the input error may be highlighted or colored in order to draw attention to the error in that field. In alternate embodiments, the error message 325 may also be highlighted, colored, or presented in a stylized fashion so it is easily recognizable as the error message 325 and not the original form label 305. In this example, the error message 325 is displayed in the center of the form field 325 and its size is adjusted to fit inside the form field 325. In alternate embodiments, the error message 325 can be sized in any suitable fashion and can be presented in any suitable area of the form field 325.

In one embodiment, once the label size has been reduced, the form label 315 and entered data 320 can be simultaneously viewed in the form field. This can provide the advantage of being able to clearly see what information is required in that form field while simultaneously entering the data and viewing the entered data. In another embodiment, the label 315 remains at this reduced size until the form and data are finalized or submitted. In one embodiment, the user can toggle the form field labels on and off. By being able to view the data label while entering the data, the user may enter the data more correctly, without forgetting the required information for that form field.

In one embodiment, when the form and data are finalized or submitted, only the entered data 320 is recognized as form input. In this embodiment, the form submission does not include the label 315 or the identifier 310, but only the entered data 320. In alternate embodiments, the label 315 and the identifier 310 can be formatted as background characters that are not recognizable as part of the submission and are distinguished from the entered data 320 in the completed form.

The exemplary interface as described above is shown in FIG. 3A-3C as a user interface in which data, such as text, may be entered manually by using input devices such as, for example, a keypad or a stylus. The disclosed embodiments as described above may also be implemented on a form that uses drop down type form fields, as shown in FIG. 3D-3E. In FIG. 3D, the form label 340 is presented inside a drop down type form field 335. In this type of form field, a user activates a drop down menu by selecting the arrow button 342 on the right hand side of the form field 335. Once the user has selected one of the available data entry options, and the selection has been detected, the form label 340 is reduced in size, to that of form label 350, shown in FIG. 3E, so that both the label 350 and the entered data 355 are simultaneously viewable inside the form field 335 in a non-interfering manner. In accordance with the aspects of the disclosed embodiments, an identifier 345 may be added to the label 350. Form label 340 may be positioned in any suitable fashion inside form field 335, and form labels 340 and 350 may be colored or formatted in a stylized manner, as previously disclosed with regard to form labels 305 and 315 of FIGS. 3A and 3B.

The input device(s) 104 are generally configured to allow a user to input data, instructions and commands to the system 100. In one embodiment, the input device 104 can be configured to receive input commands remotely or from another device that is not local to the system 100. The input device 104 can include devices such as, for example, keys 110, touch screen 112, menu 124, a camera device 125 or such other image capturing system. In alternate embodiments the input device can comprise any suitable device(s) or means that allows or provides for the input and capture of data, information and/or instructions to a device, as described herein. The output device(s) 106 are configured to allow information and data to be presented to the user via the user interface 102 of the system 100 and can include one or more devices such as, for example, a display 114, audio device 115 or tactile output device 116. In one embodiment, the output device 106 can be configured to transmit output information to another device, which can be remote from the system 100. While the input device 104 and output device 106 are shown as separate devices, in one embodiment, the input device 104 and output device 106 can be combined into a single device, and be part of and form, the user interface 102. The user interface 102 can be used to receive and display information pertaining to content, objects and targets, as will be described below. While certain devices are shown in FIG. 1, the scope of the disclosed embodiments is not limited by any one or more of these devices, and an exemplary embodiment can include, or exclude, one or more devices. For example, in one exemplary embodiment, the system 100 may not include a display or only provide a limited display, and the input devices, or application opening or activation function, may be limited to the key 108a of the headset device.

The process module 122 is generally configured to execute the processes and methods of the disclosed embodiments. The application process controller 132 can be configured to interface with the applications module 180, for example, and execute applications processes with respects to the other modules of the system 100. In one embodiment the applications module 180 is configured to interface with applications that are stored either locally to or remote from the system 100 and/or web-based applications. The applications module 180 can include any one of a variety of applications that may be installed, configured or accessible by the system 100, such as for example, office, business, media players and multimedia applications, web browsers and maps. In alternate embodiments, the applications module 180 can include any suitable application. The communication module 134 shown in FIG. 1 is generally configured to allow the device to receive and send communications and messages, such as text messages, chat messages, multimedia messages, video and email, for example. The communications module 134 is also configured to receive information, data and communications from other devices and systems.

In one embodiment, the system 100 can also include a voice recognition system 142 that includes a text-to-speech module that allows the user to receive and input voice commands, prompts and instructions. For example, in one embodiment, data inputs to the form fields 300 are inputted via voice commands.

The user interface 102 of FIG. 1 can also include menu systems 124 coupled to the processing module 122 for allowing user input and commands. The processing module 122 provides for the control of certain processes of the system 100 including, but not limited to the controls for selecting files and objects, accessing and opening forms, and entering and viewing data in the forms in accordance with the disclosed embodiments. The menu system 124 can provide for the selection of different tools and application options related to the applications or programs running on the system 100 in accordance with the disclosed embodiments. In the embodiments disclosed herein, the process module 122 receives certain inputs, such as for example, signals, transmissions, instructions or commands related to the functions of the system 100, such as messages, notifications and state change requests. Depending on the inputs, the process module 122 interprets the commands and directs the process control 132 to execute the commands accordingly in conjunction with the other modules, such as forms module 136, forms label module 138 and label resizing module 140.

Referring to FIG. 1, in one embodiment, the user interface of the disclosed embodiments can be implemented on or in a device that includes a touch screen display, proximity screen device or other graphical user interface. Although a display associated with the system 100, it will be understood that a display is not essential to the user interface of the disclosed embodiments. In an exemplary embodiment, the display is limited or not available. In alternate embodiments, the aspects of the user interface disclosed herein could be embodied on any suitable device that will allow the selection and activation of applications or system content when a display is not present.

In one embodiment, the display 114 can be integral to the system 100. In alternate embodiments the display may be a peripheral display connected or coupled to the system 100. A pointing device, such as for example, a stylus, pen or simply the user's finger may be used with the display 114. In alternate embodiments any suitable pointing device may be used. In other alternate embodiments, the display may be any suitable display, such as for example a flat display 114 that is typically made of a liquid crystal display (LCD) with optional back lighting, such as a thin film transistor (TFT) matrix capable of displaying color images.

The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

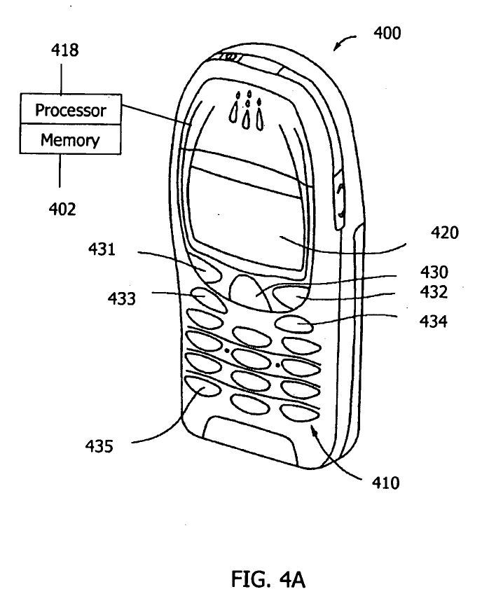

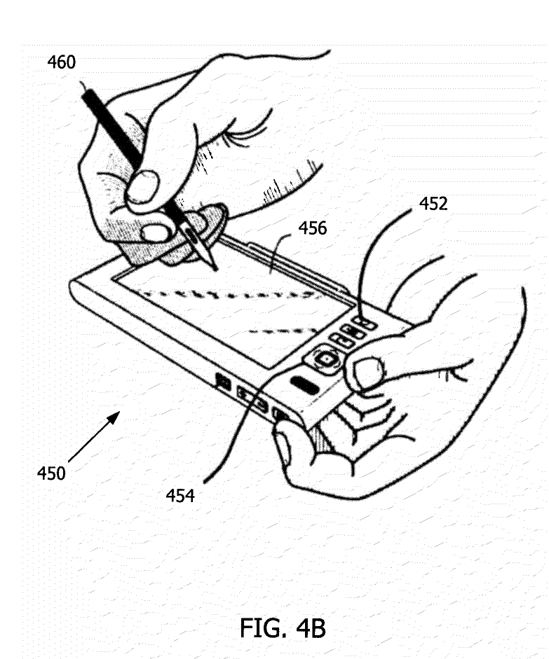

Some examples of devices on which aspects of the disclosed embodiments can be practiced are illustrated with respect to FIGS. 4A-4B. The devices are merely exemplary and are not intended to encompass all possible devices or all aspects of devices on which the disclosed embodiments can be practiced. The aspects of the disclosed embodiments can rely on very basic capabilities of devices and their user interface. Buttons or key inputs can be used for selecting the various selection criteria and links, and a scroll function can be used to move to and select item(s).

FIG. 4A illustrates one example of a device 400 that can be used to practice aspects of the disclosed embodiments. As shown in FIG. 4A, in one embodiment, the device 400 may have a keypad 410 as an input device and a display 420 for an output device. The keypad 410 may include any suitable user input devices such as, for example, a multi-function/scroll key 430, soft keys 431, 432, a call key 433, an end call key 434 and alphanumeric keys 435. In one embodiment, the device 400 can include an image capture device such as a camera (not shown) as a further input device. The display 420 may be any suitable display, such as for example, a touch screen display or graphical user interface. The display may be integral to the device 400 or the display may be a peripheral display connected or coupled to the device 400. A pointing device, such as for example, a stylus, pen or simply the user's finger may be used in conjunction with the display 420 for cursor movement, menu selection and other input and commands. In alternate embodiments any suitable pointing or touch device, or other navigation control may be used. In other alternate embodiments, the display may be a conventional display. The device 400 may also include other suitable features such as, for example a loud speaker, tactile feedback devices or connectivity port. The mobile communications device may have a processor 418 connected or coupled to the display for processing user inputs and displaying information on the display 420. A memory 402 may be connected to the processor 418 for storing any suitable information, data, settings and/or applications associated with the mobile communications device 400.

Although the above embodiments are described as being implemented on and with a mobile communication device, it will be understood that the disclosed embodiments can be practiced on any suitable device incorporating a processor, memory and supporting software or hardware. For example, the disclosed embodiments can be implemented on various types of music, gaming and multimedia devices. In one embodiment, the system 100 of FIG. 1 may be for example, a personal digital assistant (PDA) style device 450 illustrated in FIG. 4B. The personal digital assistant 450 may have a keypad 452, cursor control 454, a touch screen display 456, and a pointing device 460 for use on the touch screen display 456. In still other alternate embodiments, the device may be a personal computer, a tablet computer, touch pad device, Internet tablet, a laptop or desktop computer, a mobile terminal, a cellular/mobile phone, a multimedia device, a personal communicator, a television set top box, a digital video/versatile disk (DVD) or high definition player or any other suitable device capable of containing for example a display 114 shown in FIG. 1, and supported electronics such as the processor 418 and memory 402 of FIG. 4A. In one embodiment, these devices will be Internet enabled and include GPS and map capabilities and functions.

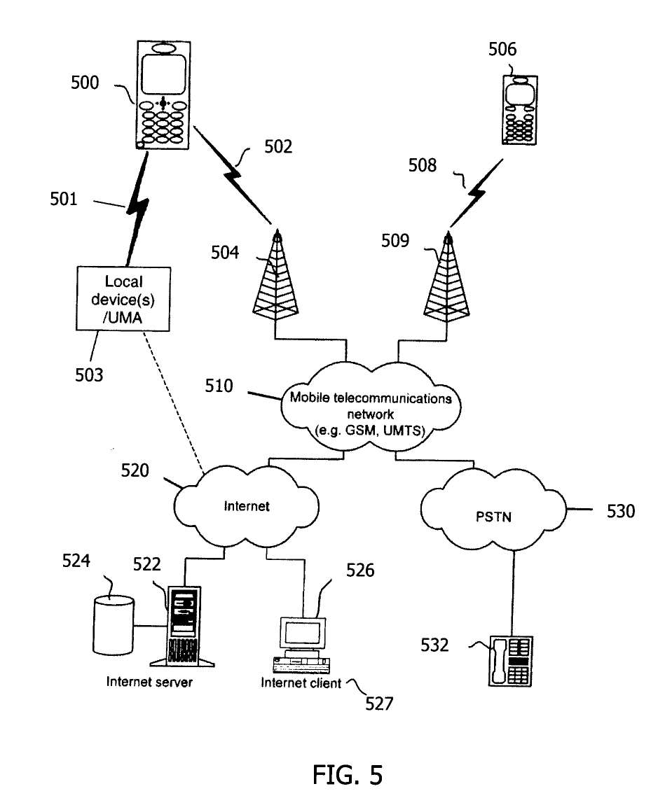

In the embodiment where the device 400 comprises a mobile communications device, the device can be adapted for communication in a telecommunication system, such as that shown in FIG. 5. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 500 and other devices, such as another mobile terminal 506, a line telephone 532, a personal computer 526 and/or an internet server 522.

In one embodiment the system is configured to enable any one or combination of chat messaging, instant messaging, text messaging and/or electronic mail. It is to be noted that for different embodiments of the mobile device or terminal 500, and in different situations, some of the telecommunications services indicated above may or may not be available. The aspects of the disclosed embodiments are not limited to any particular set of services or communication, protocol or language in this respect.

The mobile terminals 500, 506 may be connected to a mobile telecommunications network 510 through radio frequency (RF) links 502, 508 via base stations 504, 509. The mobile telecommunications network 510 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 510 may be operatively connected to a wide-area network 520, which may be the Internet or a part thereof. An Internet server 522 has data storage 524 and is connected to the wide area network 520, as is an Internet client 527. The server 522 may host a worldwide web/wireless application protocol server capable of serving worldwide web/wireless application protocol content to the mobile terminal 500. The mobile terminal 500 can also be coupled via link 742 to the internet 520′. In one embodiment, link 742 can comprise a wired or wireless link, such as a Universal Serial Bus (USB) or Bluetooth™ connection, for example.

A public switched telephone network (PSTN) 530 may be connected to the mobile telecommunications network 510 in a familiar manner. Various telephone terminals, including the stationary telephone 532, may be connected to the public switched telephone network 530.

The mobile terminal 500 is also capable of communicating locally via a local link 501 to one or more local devices 503. The local links 501 may be any suitable type of link or piconet with a limited range, such as for example Bluetooth™, a USB link, a wireless Universal Serial Bus (WUSB) link, an IEEE 802.11 wireless local area network (WLAN) link, an RS-232 serial link, etc. The local devices 503 can, for example, be various sensors that can communicate measurement values or other signals to the mobile terminal 500 over the local link 501. The above examples are not intended to be limiting, and any suitable type of link or short range communication protocol may be utilized. The local devices 503 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 500 may thus have multi-radio capability for connecting wirelessly using mobile communications network 510, wireless local area network or both. Communication with the mobile telecommunications network 510 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the navigation module 122 of FIG. 1 includes communication module 134 that is configured to interact with, and communicate with, the system described with respect to FIG. 5.

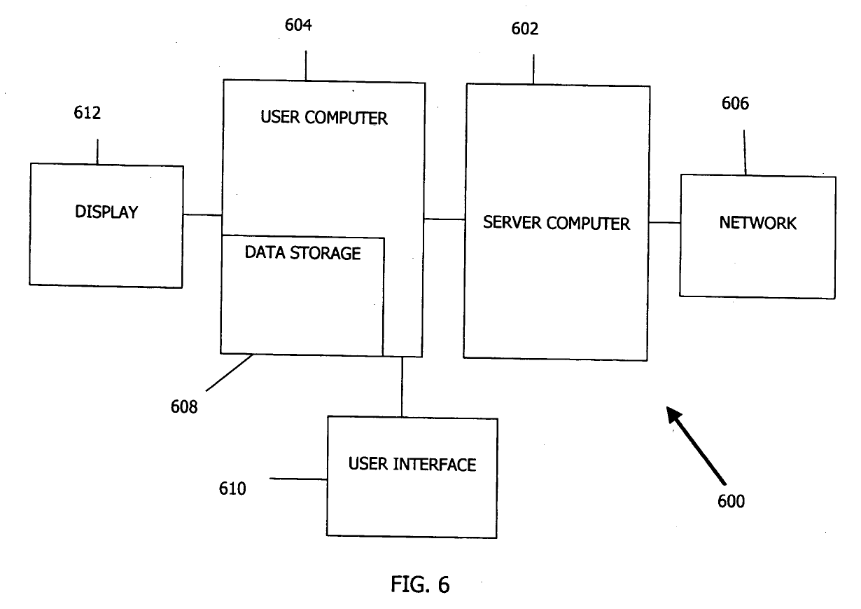

The disclosed embodiments may also include software and computer programs incorporating the process steps and instructions described above. In one embodiment, the programs incorporating the process steps described herein can be executed in one or more computers. FIG. 6 is a block diagram of one embodiment of a typical apparatus 600 incorporating features that may be used to practice aspects of the invention. The apparatus 600 can include computer readable program code means for carrying out and executing the process steps described herein. In one embodiment the computer readable program code is stored in a memory of the device. In alternate embodiments the computer readable program code can be stored in memory or memory medium that is external to, or remote from, the apparatus 600. The memory can be direct coupled or wireless coupled to the apparatus 600. As shown, a computer system 602 may be linked to another computer system 604, such that the computers 602 and 604 are capable of sending information to each other and receiving information from each other. In one embodiment, computer system 602 could include a server computer adapted to communicate with a network 606. Alternatively, where only one computer system is used, such as computer 604, computer 604 will be configured to communicate with and interact with the network 606. Computer systems 602 and 604 can be linked together in any conventional manner including, for example, a modem, wireless, hard wire connection, or fiber optic link. Generally, information can be made available to both computer systems 602 and 604 using a communication protocol typically sent over a communication channel or other suitable connection or line, communication channel or link. In one embodiment, the communication channel comprises a suitable broad-band communication channel. Computers 602 and 604 are generally adapted to utilize program storage devices embodying machine-readable program source code, which is adapted to cause the computers 602 and 604 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 602 and 604 may also include a microprocessor for executing stored programs. Computer 602 may include a data storage device 608 on its program storage device for the storage of information and data. The computer program or software incorporating the processes and method steps incorporating aspects of the disclosed embodiments may be stored in one or more computers 602 and 604 on an otherwise conventional program storage device. In one embodiment, computers 602 and 604 may include a user interface 610, and/or a display interface 612 from which aspects of the invention can be accessed. The user interface 610 and the display interface 612, which in one embodiment can comprise a single interface, can be adapted to allow the input of queries and commands to the system, as well as present the results of the commands and queries, as described with reference to FIG. 1, for example.

The aspects of the disclosed embodiments allow a user to clearly identify what information is required in a form field on a form, and they also reduce the amount of space required to display the form fields, especially on a small screen device. The reduced space requirement allows for forms to be more clearly spaced, or for form fields to be made larger for example, on a touch screen display. By displaying the form label inside the form before, during and after data entry, the user is able to input the required information with more ease and accuracy.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
providing a form label of a first size inside a form field where data is to be entered;
detecting data entry into the form field; and
reducing the form label to a second smaller size when data is entered into the form field, so that both the form label and entered data are simultaneously viewable in the form field.

2. The method of claim 1, wherein the form labels of both the first and second sizes are formatted so as to distinguish them from the entered data and any other text on the form.

3. The method of claim 1, wherein the form label remains in the form field at the second smaller size with the entered data until the form is submitted or cleared.

4. The method of claim 1, further comprising that the form label is positioned within the form either above or below the entered data.

5. The method of claim 4, further comprising that the second smaller size allows the form label and entered data to co-exist in the form field in a non-interfering manner.

6. The method of claim 1, further comprising that an identifier is added to the reduced size form label.

7. The method of claim 1, further comprising:
detecting an error in the data entry; and
replacing the form label with an error message.

8. The method of claim 7, further comprising that the error message is highlighted relative to the form labels of other form fields.

9. The method of claim 7, further comprising that the form field is highlighted relative to other form fields on the form.

10. The method of claim 1, further comprising that only the entered data is recognized as a form field input during submission of a form including the form field.

11. The method of claim 10, further comprising that the form label is formatted as background characters and is not recognizable as data entry in the form field.

12. The method of claim 1, further comprising:
recognizing deletion of the entered data; and
resizing the form label to the first size inside the form field.

13. The method of claim 1, wherein the form field is provided in a web based form.

14. The method of claim 9, wherein the web based form is provided on a display of a mobile communications device.

15. An apparatus comprising:
a display;
a first module configured to provide form labels for form fields on a form presented on the display; and
a second module configured to highlight a form label when data is inputted into a corresponding form field.

16. The apparatus of claim 15 where the second module is further configured to resize the form label to enable both the input data and the form label to be simultaneously viewable within the form field.

17. The apparatus of claim 16 wherein the second module is further configured to detect an error in the input data and resize the form label to its original size.

18. The apparatus of claim 15 further comprising at least one processor in the apparatus, the at least one processor including at least the first and the second module.

19. The apparatus of claim 15 wherein the display, the first module and the second module are in a mobile communications device.

20. A computer program product comprising computer readable program code means stored in a storage medium, the computer readable program code means being configured to execute the method according to claim 1.
